(19) United States
(12) Patent Application Publication
(10) Pub. No.: US 2008/0197211 A1
(43) Pub. Date: Aug. 21, 2008

(54) Periodic mechanism for sprinklers

(76) Inventor: Pai-Chou Hsieh, Changhwa Hsien (TW)

Correspondence Address: CHARLES E. BAXLEY, ESQUIRE, 90 JOHN STREET, SUITE 309, NEW YORK, NY, 10038, US

(21) Appl. No.: 11/708,374

(22) Filed: Feb. 20, 2007

(51) Int. Cl. B05B 3/16

(52) U.S. Cl. 239/242

(57) ABSTRACT

A periodical mechanism of a sprinkler includes a casing and a wheel is received in the casing to introduce water into a chamber of the casing in which a gear set is received. The gear set includes multiple gears and is connected between the wheel and a rotatable member which has a plurality of openings and closed areas. The casing includes a cover which includes an outlet so as to introduce water into the sprinkler. The outlet includes multiple openings and closed areas so that when the wheel is rotated by water entering the casing, the gear set drives the rotatable member. The water periodically enters into the sprinkler when the respective openings of the rotatable member and the cover are in alignment with each other.

### FIELD OF THE INVENTION

The present invention relates to a periodic mechanism for a sprinkler so as to provide a periodic sprinkling feature to the sprinkler.

### BACKGROUND OF THE INVENTION

A conventional sprinkler 10 is shown in FIG. 1 and generally includes a casing with an inlet 11 in an end of the casing, water is introduced therein via the inlet 11 and drives a wheel 12 which includes a co-axial worm rod 13 which drives a worm gear 14 on a shaft. A cylindrical member 15 is connected to the shaft and includes a spiral groove 151 in which a protrusion 161 of a movable member 16 is engaged so that when the cylindrical member 15 is rotated, the movable member 16 is moved back and forth with an elongate slot 171 of a tubular member 17. The movable member 16 moves in and out relative to an outlet 18 defined in the other end of the casing so as to provide different patterns of sprinkling feature. However, during operation, water enters into the tubular member 17 via the elongate slot 171 and forms a resistance which slows the movement of the movable member 16. The impact of water pressure to the movable member 16 might damage the engagement of the worm rod 13 and the worm gear 14.

The present invention intends to provide a periodic mechanism which uses a gear set to drive a rotatable member which is cooperated with a cover, and both of which have openings and closed areas so that water are allowed to periodically flow out from the sprinkler.

### SUMMARY OF THE INVENTION

The present invention relates to a sprinkler which comprises a main body having a locking tube for being connected to a periodic mechanism, a swing tube is connected between two ends of the main body and has a plurality of apertures. The swing tube communicates with the locking tube from which water is introduced into the sprinkler. The periodical mechanism includes a casing which has a first chamber and a second chamber defined in a first end thereof. An inlet and a through hole are defined in communication between the first and second chambers. An outlet is defined in a second end of the casing and includes a plurality of first openings and closed areas. A wheel is received in the first chamber and has a plurality of radial blades so that when water is supplied to the casing the wheel rotates by the water.

A gear set is received in the second chamber and connected between the wheel and the rotatable member which is driven by the gear set and located at the outlet of the casing. The rotatable member has a plurality of second openings and second closed areas. The second openings and the second closed areas are removably aligned with the first openings and first closed areas of the casing. An inlet end cap is mounted to the first end of the casing and communicates with the first chamber. A central passage is defined through the inlet end cap and communicates with the first chamber.

The primary object of the present invention is to provide a periodic mechanism of a sprinkler and the periodical mechanism let water flow out from the apertures of the swing tube periodically.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional sprinkler;

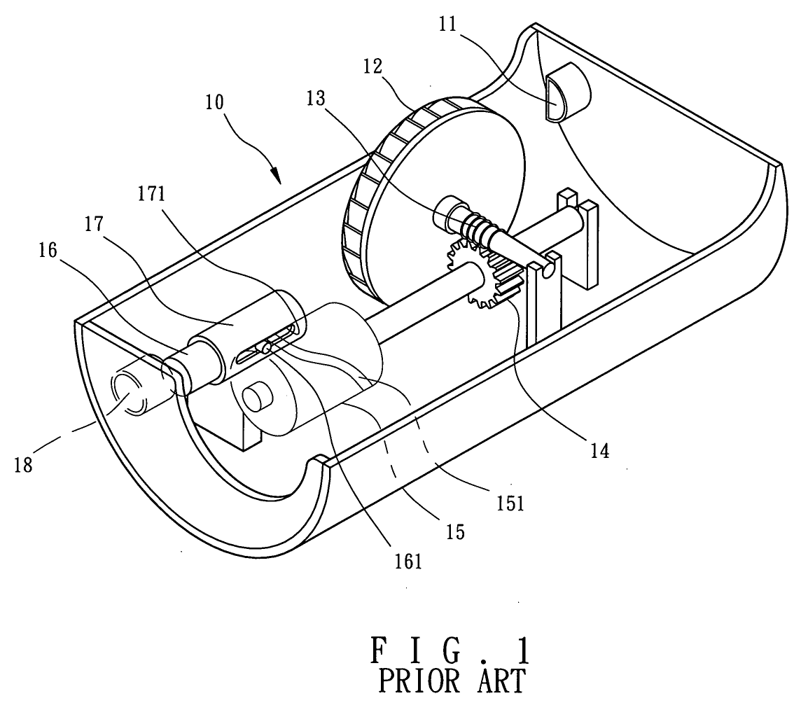

FIG. 2 shows the sprinkler of the present invention;

FIG. 3 is an exploded view to show the periodical mechanism of the present invention;

FIG. 4 is an exploded view to show the periodical mechanism of the present invention wherein the gear set is assembled in the base;

FIG. 5 is a cross sectional view to show the periodical mechanism of the present invention;

FIG. 6 shows that water drives the wheel;

FIG. 7 is a cross sectional view to show that the water is blocked by aligned closed areas of the rotatable member and the cover.

### DETAILED DESCRIPTION OF THE PREFERRED EMBODIMENT

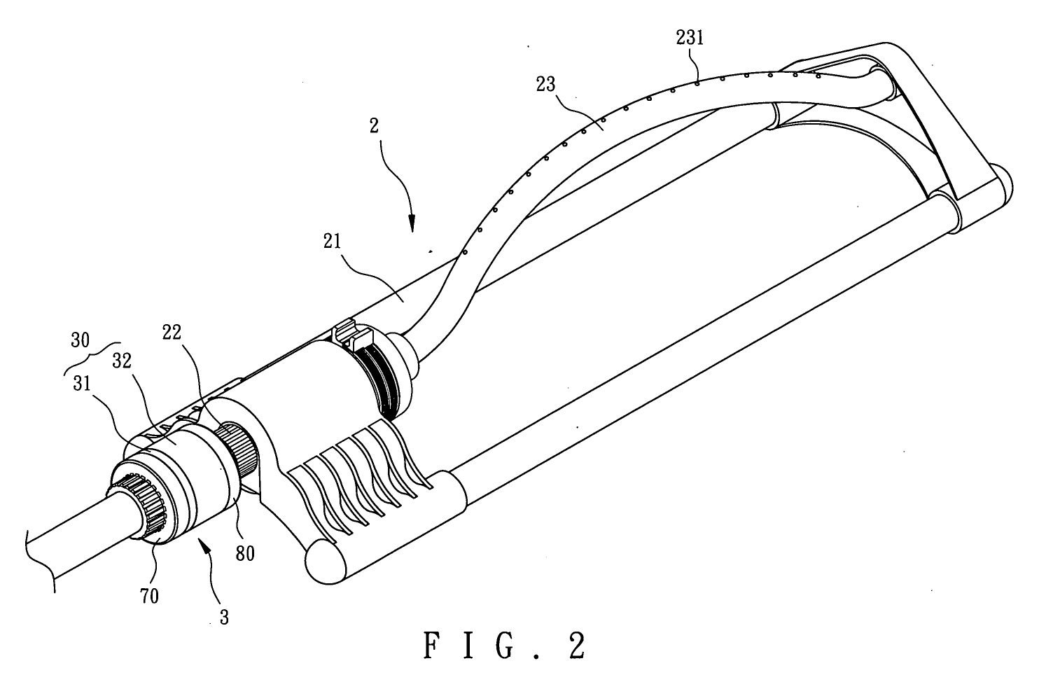

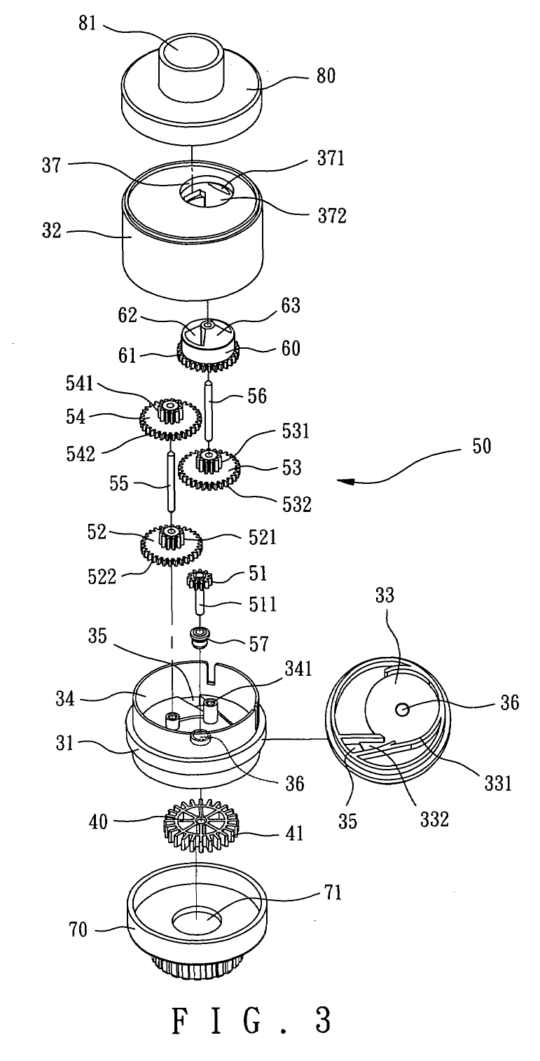

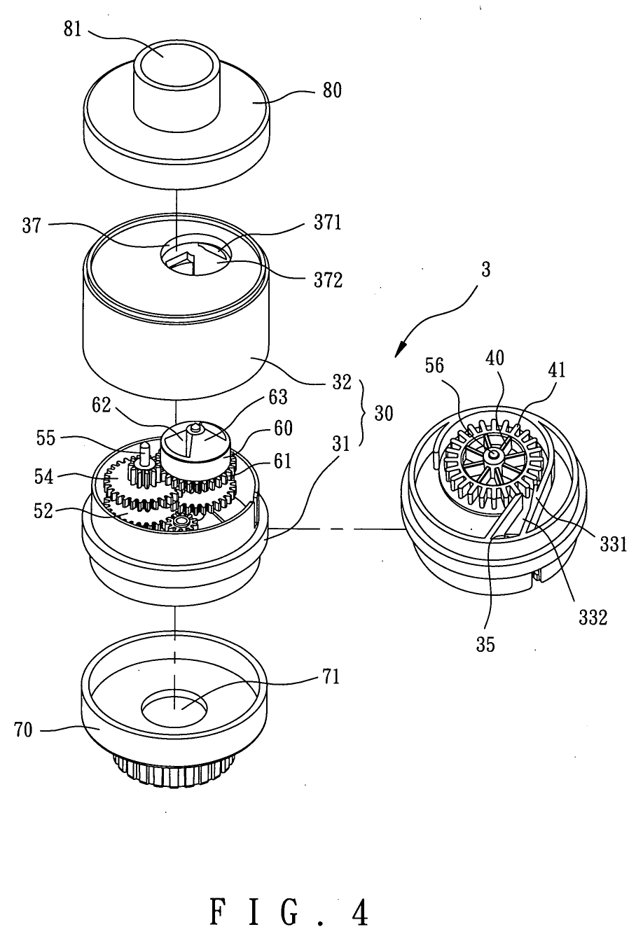

Referring to FIGS. 2 to 4, the sprinkler 2 of the present invention comprises a rectangular main body 21 and a locking tube 22 is connected thereto. A swing tube 23 is connected between two ends of the main body 21 and has a plurality of apertures 231. The swing tube 23 communicates with the locking tube 22 from which water is introduced into the swing tube 23 so that water flows out from the apertures 231.

A periodic mechanism 3 includes a casing which is connected to the locking tube 22 and composed of a base 31 and a cover 32 which is mounted to the base 31. A first chamber 33 and a second chamber 34 are defined in two opposite ends of the base 31 located at a first end of the casing 30. An inlet 35 and a through hole 36 are defined in communication between the first and second chambers 33, 34. An outlet 37 is defined in the cover 32 which is located at a second end of the casing 30. The outlet 37 includes a plurality of first openings 371 and closed areas 372.

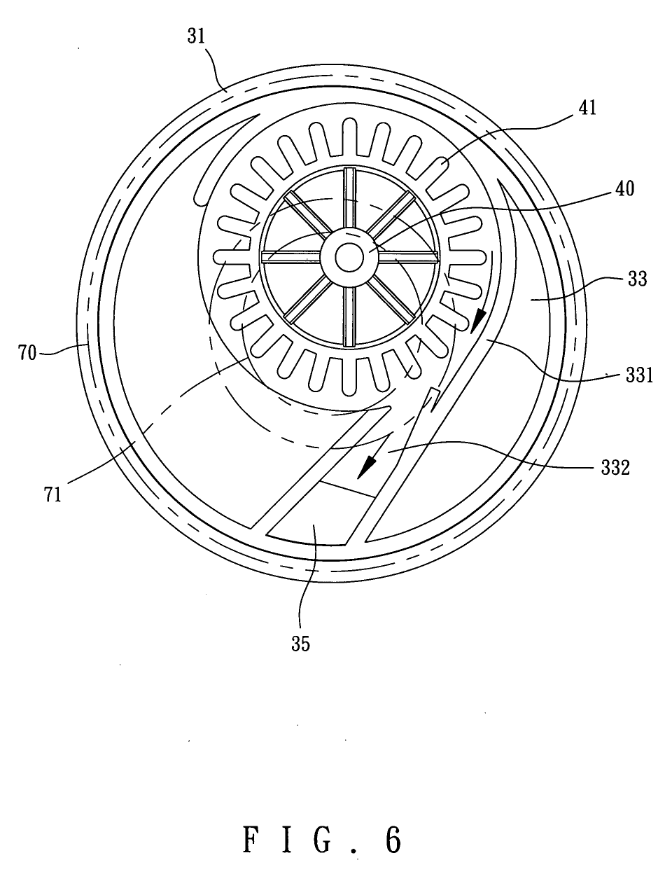

Further referring to FIG. 6, a wheel 40 with a plurality of radial blades 41 is received in the first chamber 33 and a path 332 is defined in an inner end of the first chamber 33 by guide plates 331 which partially enclose the wheel 40. The path 332 is orientated in tangent direction to the wheel 40 and communicates with the inlet 35 so that when water enters into the first chamber 33, the wheel 40 is rotated by the water which is then introduced into the second chamber 34 via the inlet 35. An inlet end cap 70 is mounted to the base 31 and communicates with the first chamber 33. A central passage 71 is defined through the inlet end cap 70 and communicates with the first chamber 33. An end of a hose is connected to the inlet end cap 70 and the other end of the hose is connected with a faucet which is not shown.

A gear set 50 is received in the second chamber 34 and connected between the wheel 40 and a rotatable member 60 which is driven by the gear set 50 and located at the outlet 37 of the casing 30. The rotatable member 60 has a plurality of second openings 62 and second closed areas 63. The second openings 62 and the second closed areas 63 are removably aligned with the first openings 371 and first closed areas 372 of the casing 30 when the rotatable member 60 rotates. An out end cap 80 is connected to the cover 32 located at the second end of the casing 30 and includes an extension tube 81 which is connected with the locking tube 22. The gear set 50 includes a first gear 51, a second gear 52, a third gear 53, a fourth gear 54 and two rods 55, 56. The first gear 51 has a shank 511 which extends through the through hole 36 and is connected with the wheel 40. A bush 57 is located between the shank 511 of the first gear 50 and the through hole 36 to prevent from leakage. The second gear 52 has a first co-axial gear 521 and first outer teeth 522, and the third gear 53 has a second co-axial gear 531 and second outer teeth 532. The fourth gear 54 has a third co-axial gear 541 and third outer teeth 542. The rod 55 is connected between the second gear 52 and fourth gear 54 and is positioned in one of two positioning tubes 341 in the base 31. The other rod 56 is connected between the third gear 53 and the rotatable member 60, and is positioned in the other positioning tube 341. The first gear 51 is engaged with the first outer teeth 522 of the second gear 52. The first co-axial gear 521 of the second gear 52 is engaged with the second outer teeth 532 of the third gear 53. The second co-axial gear 531 of the third gear 53 is engaged with the third outer teeth 542 of the fourth gear 54. The third co-axial gear 541 of the fourth gear 54 is engaged with peripheral teeth 61 of the rotatable member 60.

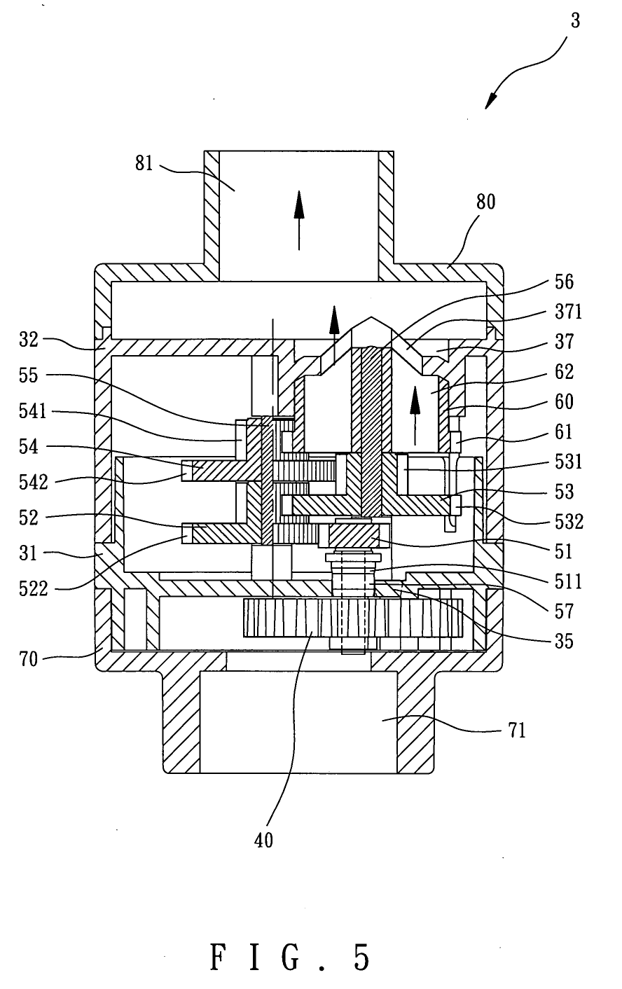

As shown in FIG. 5, when water is introduced into the first chamber 33 to rotate the wheel 40, the gear set 50 is operated and the rotatable member 60 is rotated via the engagement between the gears 51 to 54. When the first openings 371 are in alignment with the second openings 62, water passes through the aligned openings 371, 62 and enters into the swing tube 23.

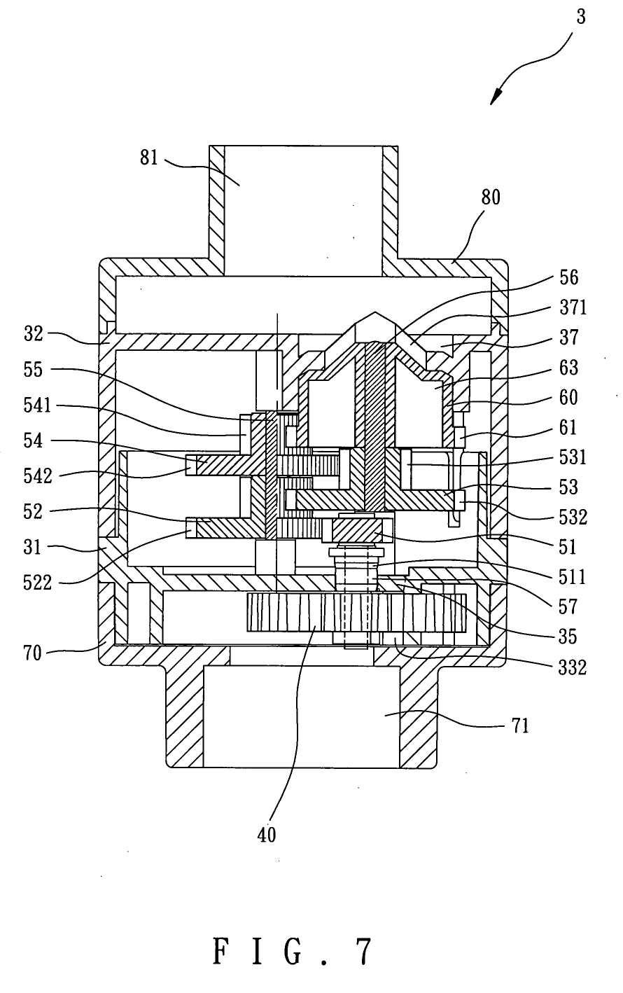

As shown in FIG. 7, when the first closed areas 372 are in alignment with the second openings 62, water cannot pass so that water is stopped for a short of period till the rotatable member 60 rotates a further angle to align the first openings 371 and the second openings 62.

While we have shown and described the embodiment in accordance with the present invention, it should be clear to those skilled in the art that further embodiments may be made without departing from the scope of the present invention.

What is claimed is:

1. A sprinkler comprising:
a main body having a locking tube connected thereto and a periodic mechanism connected to the locking tube, a swing tube connected between two ends of the main body and having a plurality of apertures, the swing tube communicating with the locking tube;
the periodical mechanism including a casing which has a first chamber and a second chamber defined in a first end thereof, an inlet and a through hole defined in communication between the first and second chambers, an outlet defined in a second end of the casing and including a plurality of first openings and closed areas, a wheel received in the first chamber and having a plurality of radial blades, a path defined in an inner end of the first chamber by guide plates which partially enclose the wheel, the path being orientated in tangent direction to the wheel and communicating with the inlet, a gear set received in the second chamber and connected between the wheel and a rotatable member, the rotatable member driven by the gear set and located at the outlet of the casing, the rotatable member having a plurality of second openings and second closed areas, the second openings and the second closed areas being removably aligning with the first openings and first closed areas of the casing, and
an inlet end cap mounted to the first end of the casing and communicating with the first chamber, a central passage defined through the inlet end cap and communicating with the first chamber.

2. The sprinkler as claimed in claim 1, wherein the casing is composed of a base and a cover which is mounted to the base, the first and second chambers are defined in two opposite ends of the base, the outlet is defined in the cover.

3. The sprinkler as claimed in claim 1, wherein the gear set includes a first gear, a second gear, a third gear, a fourth gear and two rods, the first gear has a shank which extends through the through hole and is connected with the wheel, the second gear has a first co-axial gear and first outer teeth, the third gear has a second co-axial gear and second outer teeth, the fourth gear has a third co-axial gear and third outer teeth, one of the two rods is connected between the second gear and fourth gear, the other rod is connected between the third gear and the rotatable member, the first gear is engaged with the first outer teeth of the second gear, the first co-axial gear of the second gear is engaged with the second outer teeth of the third gear, the second co-axial gear of the third gear is engaged with the third outer teeth of the fourth gear, the third co-axial gear of the fourth gear is engaged with peripheral teeth of the rotatable member.

4. The sprinkler as claimed in claim 3, wherein a bush is located between the shank of the first gear and the through hole.

5. The sprinkler as claimed in claim 1, wherein an out end cap is connected to the second end of the casing and includes an extension tube which is connected with the locking tube.
